(19) United States
(12) Patent Application Publication
(10) Pub. No.: US 2012/0242589 A1
(43) Pub. Date: Sep. 27, 2012

(54) Computer Interface Method

(75) Inventors: Dominik Schmidt, Lancaster (GB); Fadi Chehimi, Lancaster (GB); Hans-Werner Gellersen, Lancaster (GB); Enrico Rukzio, Lancaster (GB)

(73) Assignee: UNIVERSITY OF LANCASTER, Lancaster (GB)

(21) Appl. No.: 13/151,554

(22) Filed: Jun. 2, 2011

Related U.S. Application Data
(63) Continuation-in-part of application No. 13/071,475, filed on Mar. 24, 2011, now abandoned.

(51) Int. Cl. G06F 3/041

(52) U.S. Cl. 345/173

(57) ABSTRACT

A method of interacting with a first electronic device having a touch-sensitive display. The method comprises establishing a connection between the first electronic device and a second electronic device, the connection allowing data communication between the first electronic device and the second electronic device. A first event involving the first electronic device is detected and a second event involving the second electronic device is detected. It is determined if the first event and the second event relate to an interaction between the second electronic device and an element displayed on the touch-sensitive display. If the first and second events relate to an interaction between the second electronic device and an element displayed on the touch-sensitive display, operation of the first electronic device is controlled based upon one or more characteristics of the interaction.

### CROSS REFERENCE TO RELATED APPLICATIONS

This application is a continuation-in-part of co-pending U.S. patent application Ser. No. 13/071,475, entitled “Computer Interface Method,” by Dominik Schmidt, Fadi Chehimi, Hans-Werner Gellersen and Enrico Rukzio, filed Mar. 24, 2011, which is hereby incorporated by reference.

### BACKGROUND OF THE INVENTION

The present invention relates to a method of interacting with an electronic device and more particularly to methods for interaction between first and second electronic devices.

As computers have become, and continue to become, increasingly pervasive within society and the workplace, so the need for new ways to interact with those computers has developed. Standard methods of computer interaction, generally using a keyboard and a mouse, work well for many common tasks performed on computers such as desktop and laptop computers. Increasingly, however, powerful, multitasking, computers are being incorporated into smaller personal devices (such as personal digital assistants, mobile telephones and tablet computers) while surfaces of everyday objects such as tables, and walls can now be used as interactive display screens.

While similar tasks may be performed on smaller computers as would be performed on a desktop computer, interaction using a standard keyboard and mouse is often unfeasible and, where feasible, provides an unsatisfactory and constrained user experience. Additionally, smaller computers and “surface” computers allow new operations, which are not, in general, performed on desktop computers. Such tasks require new methods of user interaction. For example, surface computers allow multiple users to simultaneously interact with applications running on those computers. Such collective interaction is best facilitated through means other than keyboards and mice.

Touch screens provide a method of interacting with portable devices which can, to some extent, free a user from the physical constraints of a mouse and keyboard. In this way, the functionality of both a mouse and a keyboard can be replicated using the screen itself, allowing a user to select objects on the screen and to input text and other characters using an onscreen keyboard. Touch screens which detect concurrent multiple touches upon a surface of the screen provide an input means suitable for simultaneous use by a plurality of users, and facilitate more natural methods of interaction, such as expressive gestures.

Interaction with touch screens is generally either by use of a stylus held by a user, by use of a user's finger(s), or a combination of both. Such modes of interaction generally allow the performance of a limited range of simple interactions and gestures.

### SUMMARY OF THE INVENTION

According to a first aspect of the present invention there is provided a method of interacting with a first electronic device having a touch-sensitive display, the method comprising: establishing a connection between said first electronic device and a second electronic device, said connection allowing data communication between the first electronic device and the second electronic device; detecting a first event involving said first electronic device; detecting a second event involving said second electronic device; determining if said first event and said second event relate to an interaction between said second electronic device and an element displayed on said touch-sensitive display; if said first and second events relate to an interaction between said second electronic device and an element displayed on said touch-sensitive display, controlling operation of said first electronic device based upon one or more characteristics of said interaction.

In this way, it can be determined whether interactions with elements displayed on the touch sensitive screen of the first electronic device are associated with the second electronic device, and subsequent processing can therefore be based upon whether the interaction is, or is not, associated with the second electronic device. This provides a large range of options for subsequent processing, not available using standard modes of operation. The second electronic device may be used as a ‘pointing device’ for interaction with the first electronic device. More particularly, the connection between the first electronic device and the second electronic device allow the second electronic device to be used as an ‘intelligent’ pointing device.

The element of the touch-sensitive display may be an area of the touch-sensitive display. The area of the touch sensitive display which comprises the element of the touch-sensitive display may, or may not, contain any representations of data items. For example, the element of the touch-sensitive display may be an “empty” area of the touch-sensitive display.

Establishing a connection between the first electronic device and the second electronic device may comprise synchronising respective system clocks of the first and second electronic devices.

The method may further comprise associating the first event with a first time indicated by the system clock of the first electronic device when the first event was detected and associating the second event with a second time indicated by the system clock of the second device.

Determining if the first event and the second event relate to an interaction between the second electronic device and an element displayed on the touch-sensitive display may comprise determining if the first time and the second time meet a predetermined criterion.

The predetermined criterion may be that the first time and the second time are equal to within a predetermined tolerance.

The first event may be a touch event between the first electronic device and the second electronic device. That is, the event may be the first electronic device and the second electronic device coming to into contact. A touch event may be continuous, or may be transient. That is, the touch event may relate to an event where the second electronic device and the first electronic device maintain contact for a predetermined period of time, or the touch event may relate to an event where the second electronic device is “tapped” against the first electronic device.

The element may be associated with a data item stored at the first electronic device. Controlling operation of the first electronic device may comprise transmitting a data item stored at the first electronic device to the second electronic device. The data item may relate to any data stored at the first electronic device.

The method may further comprise, if the first and second events relate to an interaction between said second electronic device and an element displayed on said touch-sensitive display, controlling operation of the second electronic device based upon one or more characteristics of the interaction.

Controlling operation of said second electronic device may comprise controlling operation of the second electronic device to provide feedback based upon one or more characteristics of the interaction. The feedback may comprise, for example, audio, visual or haptic feedback. The feedback may be provided by appropriate output devices of the second electronic device, including a display, a speaker or a vibrator.

Controlling operation of the second electronic device may comprise transmitting a data item from the second electronic device to the first electronic device.

The element may be associated with a first data entry field displayed on the touch-sensitive display and controlling operation of the second electronic device may comprise providing a second data entry field on the second electronic device corresponding to the first data entry field. Data entered at the second data entry field may then be transmitted to the first electronic device for inputting into the first data entry field. The data may be input into the first data entry field automatically, and may be input without such input appearing on a user interface of the first electronic device.

The characteristic of the interaction may be dependent upon whether a button of the second electronic device was activated during the interaction. The button may be a virtual button displayed on a touch-sensitive display of the second electronic device.

The characteristic of the interaction may be dependent upon a spatial orientation of the second electronic device during the interaction.

The characteristic of the interaction may be dependent upon data stored at the second electronic device. For example, the characteristic of the interaction may be dependent upon personal data of a user of the second electronic device.

Controlling operation of the first electronic device may comprise initiating a payment based upon payment data stored at or input via the second electronic device.

The element may be a plurality of elements.

The second electronic device may be a mobile device, such as a mobile telephone (cell phone), personal digital assistant, camera, multimedia player, navigation device, health monitor or tablet computer

According to a second aspect of the present invention, there is provided a method of interacting with a first electronic device having a touch-sensitive display, the method comprising: at the first electronic device: establishing a connection with a second electronic device, the connection allowing data communication between the first electronic device and the second electronic device; detecting a first event; determining if the first event relates to an interaction between an element displayed on the touch-sensitive screen and the second electronic device; and if the first event relates to an interaction between an element displayed on the touch-sensitive screen and the second electronic device, controlling operation of the first electronic device based upon one or more characteristics of the interaction.

Establishing a connection with the second electronic device may comprise synchronising respective system clocks of the first and second electronic devices.

The method may further comprise receiving an indication of a second event detected by the second electronic device.

The method may further comprise associating the first event with a first time indicated by the system clock of the first electronic device when the first event was detected; and associating the second event with a second time indicated by the system clock of the second device.

Determining if the first event relates to an interaction between an element displayed on the touch-sensitive screen and the second electronic device may comprise determining if the first time and the second time meet a predetermined criterion.

The predetermined criterion may be that the first time and the second time are equal to within a predetermined tolerance.

The first event may be a touch event between an element displayed on the touch-sensitive screen and the second electronic device.

The element may be associated with a data item stored at the first electronic device and controlling operation of the first electronic device may comprise transmitting the data item to the second electronic device.

The method may further comprise, if the first event relates to an interaction between an element displayed on the touch-sensitive screen and the second electronic device, controlling operation of the second electronic device based upon one or more characteristics of the interaction. For example, controlling operation of the second electronic device may comprise causing a data item to be transmitted from the second electronic device to the first electronic device.

The element may be associated with a first data entry field displayed on the touch-sensitive display and controlling operation of the second electronic device may comprise causing a second data entry field to be provided on the second electronic device corresponding to the first data entry field, and receiving at the first electronic device from the second electronic device data entered at the second data entry field for inputting into the first data entry field.

The characteristic of the interaction may be dependent upon whether a button of the second electronic device was activated during the interaction. The button may be a virtual button displayed on a touch-sensitive display of the second electronic device.

The characteristic of the interaction may be dependent upon an indication of a spatial orientation of the second electronic device during the interaction, received from the second electronic device.

Controlling operation of the first electronic device may comprise initiating a payment based upon payment data stored at or input via the second electronic device.

According to a third aspect of the present invention, there is provided a method of interacting with a first electronic device having a touch sensitive display, comprising: at a second electronic device: establishing a connection with the first electronic device, the connection allowing data communication between the first electronic device and the second electronic device; detecting a first event; determining if the first event relates to an interaction between an element displayed on the touch-sensitive screen and the second electronic device; and if the first event relates to an interaction between an element displayed on the touch-sensitive screen and the second electronic device, executing computer program code, the execution being based upon one or more characteristics of the interaction.

Establishing a connection with the first electronic device may comprise synchronising respective system clocks of the first and second electronic devices.

The method may further comprise receiving an indication of a first event detected by the first electronic device.

The method may further comprise associating the first event with a first time indicated by the system clock of the first electronic device when the first event was detected.

Determining if the first event relates to an interaction between an element displayed on the touch-sensitive screen and the second electronic device may comprise transmitting an indication of the first event and the first time to the first electronic device.

The first event may be a touch event between an element displayed on the touch-sensitive screen and the second electronic device.

The element may be associated with a data item stored at the first electronic device and executing computer program code may comprise executing computer program code to receive the data item from the first electronic device.

Executing computer program code on the second electronic device may comprise transmitting a data item from the second electronic device to the first electronic device.

The element may be associated with a first data entry field displayed on the touch-sensitive display and executing computer program code on the second electronic device may comprise causing a second data entry field to be provided on the second electronic device corresponding to the first data entry field and transmitting to the first electronic device data entered at the second data entry field for inputting into the first data entry field.

The characteristic of the interaction may be dependent upon whether a button of the second electronic device was activated during the interaction. The button may be a virtual button displayed on a touch-sensitive display of the second electronic device. Alternatively, the characteristic of the interaction may be dependent upon whether a button of the first electronic device was activated during the interaction.

The characteristic of the interaction may be dependent upon an indication of a spatial orientation of the second electronic device.

The method may further comprise transmitting an indication of a spatial orientation of the second electronic device to the first electronic device.

Executing computer program code may comprise initiating a payment based upon payment data stored at or input via the second electronic device.

It will be appreciated that aspects of the invention can be implemented in any convenient form. For example, the invention may be implemented by appropriate computer programs which may be carried out appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

It will also be appreciated that features of the invention described in connection with one aspect, may be used in combination with other aspects of the invention.

### BRIEF DESCRIPTION OF THE DRAWINGS

Embodiments of the present invention are now described, by way of example, with reference to the accompanying drawings in which:

FIG. 1 is a schematic illustration of a system comprising a mobile device, a surface computer and a remote server according to embodiments of the present invention;

FIG. 2 is a schematic illustration of a surface computer which may be used with embodiments of the present invention;

FIG. 3 is a schematic illustration of a mobile device which may be used with embodiments of the present invention;

FIG. 4 is a flowchart showing processing carried out to establish a connection between the mobile device and the surface computer of FIG. 1;

FIG. 5 is a flowchart showing processing carried out to process touch events between the mobile device and the surface computer of FIG. 1;

FIG. 6 is an illustration of contact areas caused by mobile telephones and fingers on a touch sensitive display; and

FIG. 7 is a chart showing the effect of varying a classification threshold on the misclassification rates of fingers and mobile telephones.

### DETAILED DESCRIPTION

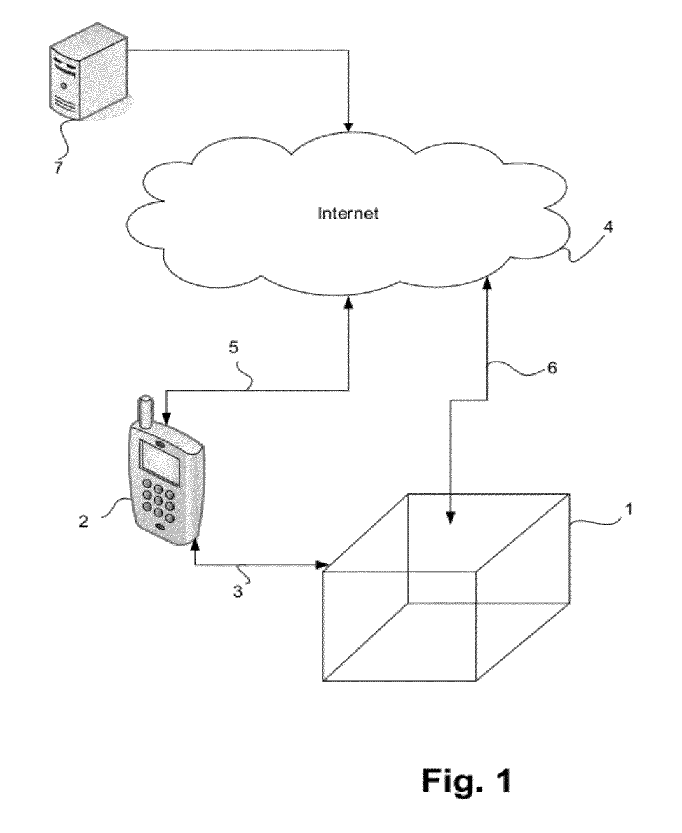

Referring to FIG. 1, a computer 1 and a mobile device 2 are connected via a wireless connection 3. In the presently described embodiment, the computer 1 takes the form of a “surface” computer, and in particular, an interactive tabletop, in which the tabletop forms the screen of the computer 1. The computer 1 may, however, take any form, and may be substantially horizontal (such as an interactive tabletop), or vertical (for example an interactive whiteboard, of the type commonly used in school classrooms). The mobile device 2 may be any mobile device such as, for example, a mobile telephone, personal digital assistant, camera, multimedia player, navigation device, health monitor or tablet computer. In the embodiments of the present invention described below, the wireless connection 3 is a Bluetooth communications link, but as will be readily apparent to those skilled in the art, any suitable wireless connection may be used (for example, an IEEE 802.11 (WiFi) connection). In other embodiments of the present invention, the connection 3 may be a wired connection. The mobile device 2 is connected to the Internet 4 via a connection 5, while the computer 1 is connected to the Internet 4 via a connection 6. The connections 5, 6 may each be wired or wireless connections. Both the mobile device 2 and the computer 1 may be connected to a remote server 7 through the Internet 6, although this is not necessary for all embodiments of the present invention.

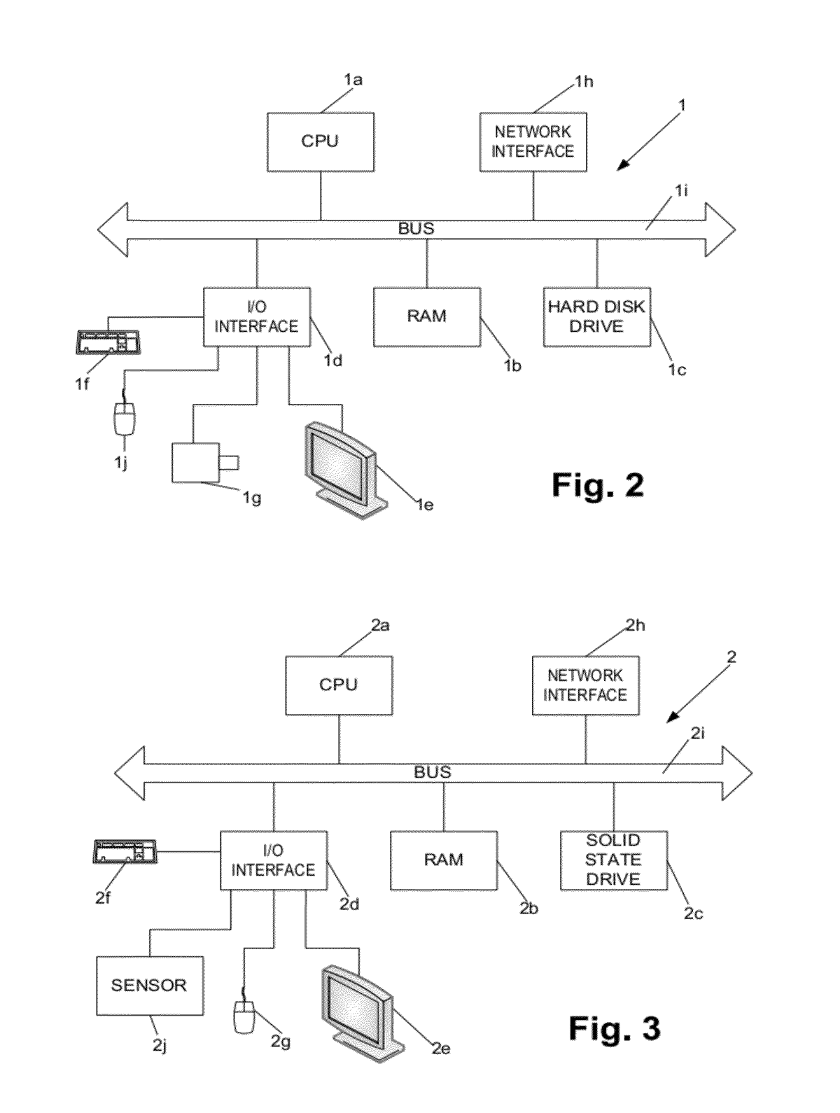

FIGS. 2 and 3 are schematic illustrations of components of the computer 1 and the mobile device 2 respectively, according to some embodiments of the present invention. It will be appreciated that the components of the computer 1 and mobile device 2 illustrated in FIGS. 2 and 3 and described below are merely exemplary, and that any suitable computer or mobile device may be used.

The computer 1 comprises a CPU 1a which is configured to read and execute instructions stored in a volatile memory 1b which takes the form of a random access memory. The volatile memory 1b stores instructions for execution by the CPU 1a and data used by those instructions. In particular, the volatile memory 1b stores instructions and data suitable for causing the computer 1 to establish a direct connection with, and to subsequently interact with, the mobile device 2.

The Computer 1 further comprises non-volatile storage in the form of a hard disc drive 1c. The computer 1 further comprises an I/O interface 1d to which are connected peripheral devices used in connection with the computer 1. More particularly, a display 1e is configured so as to display output from the computer 1. The display 1e is also a touch sensitive input device arranged to provide an interactive surface on which a, or multiple, user(s) can interact with user interfaces of computer programs operating on the computer 1. In the presently described embodiment, the display 1e is provided by a rear-projected screen with a resolution of 1280 px×800 px. Touch detection in the present embodiment is provided by FTIR (frustrated total internal reflection) methods as described by J. Y. Han in “Low-cost multi-touch sensing through frustrated total internal reflection” (Proc. UIST, pages 115-118, 2005) in combination with images of the surface provided by a camera 1g positioned below the surface of the screen. Touch screen techniques based upon FTIR are well known in the art. It will be readily apparent, however, that the touch sensitive display 1e may be provided by any suitable touch-screen display technology such as, for example, a capacitive touch screen, or by a plurality of techniques used in combination. For example, touch detection and detection of a location of that touch may be provided using FTIR in combination with contact microphones which are arranged to sense sounds generated by the interaction between an object and the touch sensitive display.

The camera 1g is connected to the I/O interface 1d to obtain images of the display 1e. The images captured by the camera 1g are processed to provide visual information, such as contact area, relating to objects in contact with the display 1e, as is described in more detail below. The camera 1g may be any suitable camera. For example, a camera having a resolution of 640 px×480 px, capturing images at 120 Hz has been successfully used in embodiments of the invention. A keyboard 1f, and a mouse 1j may be connected to the I/O interface 1d to provide input means in addition to the touch sensitive input device 1e. A network interface 1h allows the computer 1 to be connected to an appropriate computer network so as to receive and transmit data from and to other computing devices. The CPU 1a, volatile memory 1b, hard disc drive 1c, I/O interface 1d, and network interface 1h, are connected together by a bus 1i.

Referring to FIG. 3 there is shown a schematic illustration of a mobile computing device 2 which may be used with embodiments of the present invention. The mobile device 2 is a portable computing device and as such contains similar components to that of the computer 1. That is, the mobile device 2 comprises a CPU 2a which is configured to read and execute instructions stored in a volatile memory 2b which takes the form of a random access memory. The volatile memory 2b stores instructions for execution by the CPU 2a and data used by those instructions. In particular, the volatile memory 2b stores instructions suitable for causing the mobile device 2 to interact with the computer 1.

The mobile device 2 further comprises non-volatile storage in the form of a solid state drive (SSD) 2c, such as a Flash based SSD. The mobile device 2 further comprises an I/O interface 2d to which are connected peripheral devices used in connection with the mobile device 2. More particularly, a display 2e is configured so as to display output from the mobile device. The display 2e may be a touch sensitive input device. Further input devices may be connected to the I/O interface 2d. Such input devices may include a keypad 2f (for example a standard numerical telephone keypad, or alternatively, a text keyboard) and a pointing device 2g (in the form of a track pad or trackball, for example). A network interface 2h allows the mobile device 2 to be connected to an appropriate network so as to receive and transmit data from and to other mobile devices or computer devices. The network interface 2h may comprise a plurality of network interfaces to allow the mobile device 2 to connect to a plurality of networks. For example, the network interface 2h may comprise a plurality of transceivers for use with a plurality of communication protocols such as Bluetooth, WiFi, and UTMS (Universal Mobile Telecommunications System).

The mobile device 2 further comprises a sensor 2j connected to I/O interface 2d suitable for detecting a touch event involving the mobile device 2 and another object. For example, the sensor 2j may comprise an accelerometer. The sensor 2j may be internal to the mobile device 2, or may be an externally mounted sensor. A suitable sensor is the WiTilt V3 wireless accelerometer from SparkFun Electronics, Boulder, Colo., United States. Further sensors may be provided by the mobile device 2 in embodiments of the present invention, such as, for example, a microphone and/or a GPS receiver.

The CPU 2a, volatile memory 2b, solid state drive 2c, I/O interface 2d and network interface 2h are connected together by a bus 2i.

As is described in more detail below, embodiments of the present invention allow the mobile device 2 to interact with the computer 1. More particularly, once the mobile device 2 has established a connection with the computer 1, embodiments of the present invention allow the mobile device 2 to be used as a pointing device for use with the computer 1. That is, both the computer 1 and the mobile device 2 are configured so as to be able to sense interactions between one another. Physical interaction between the mobile device 2 and the computer 1 allows the mobile device 2 to interact with graphical user interface elements displayed on the display screen of the computer 1.

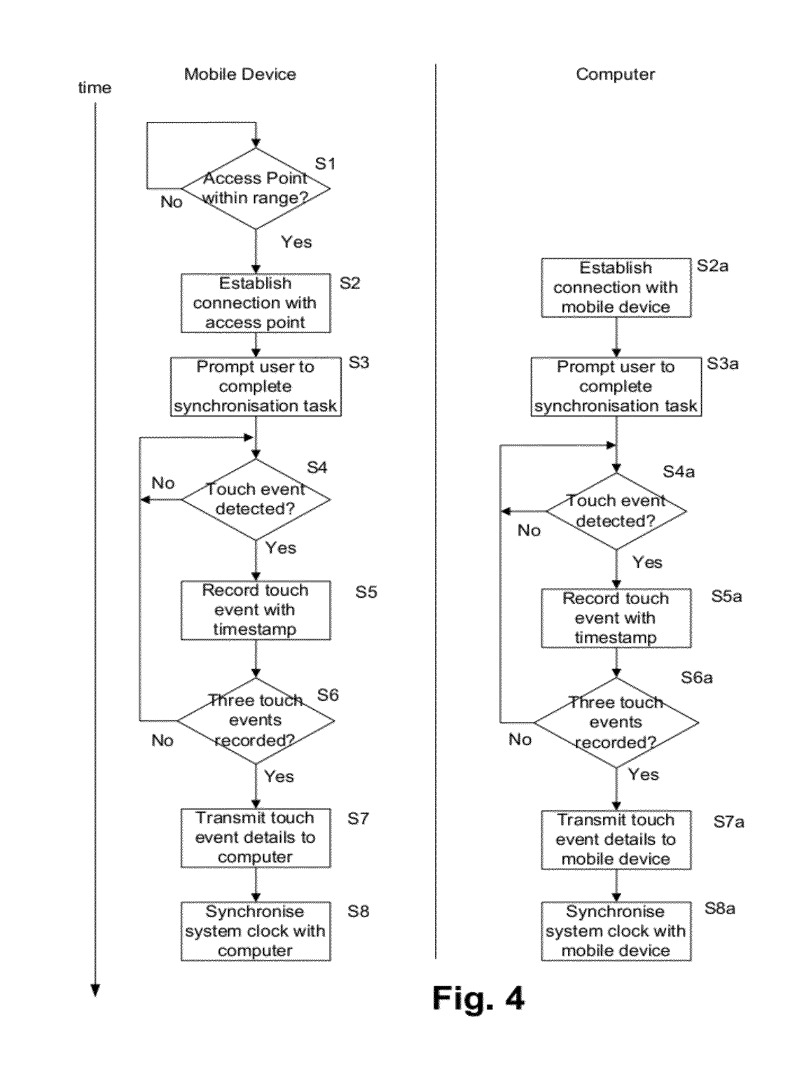

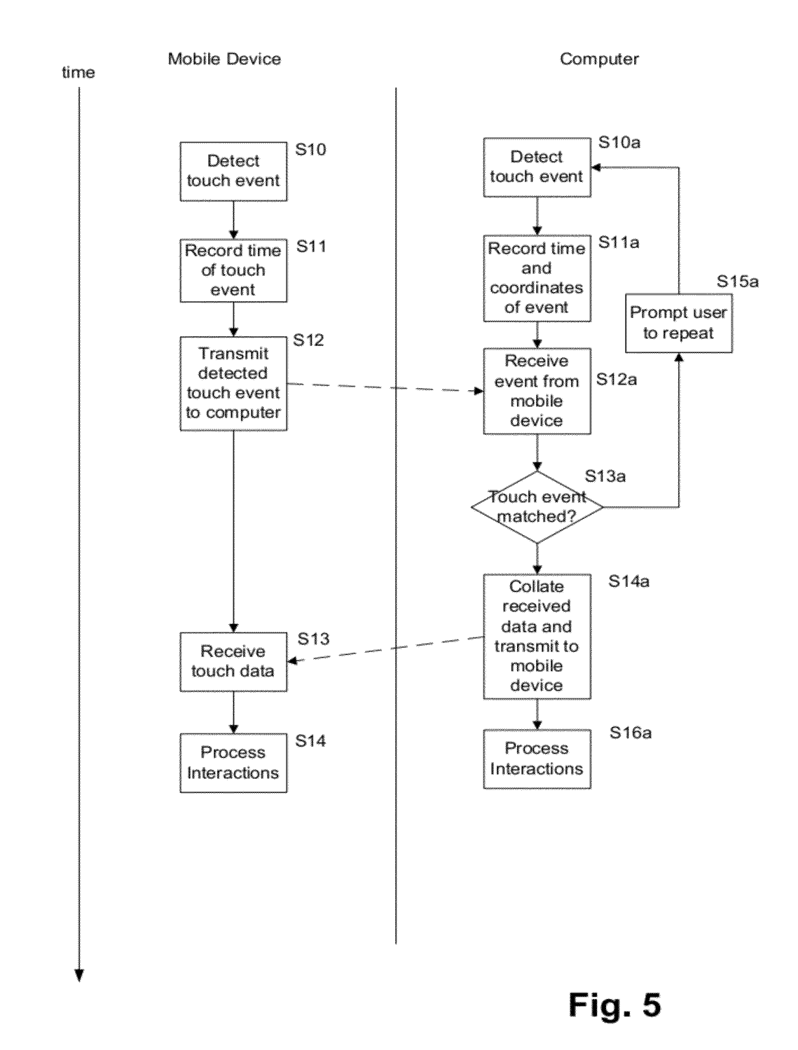

Processing performed by the computer 1 and mobile device 2 to establish a connection and synchronise their respective system clocks, is now described with reference to FIGS. 4 and 5. While the description below discusses operations performed by the mobile device 2 and the computer 1, it will be appreciated that such operations are performed by one or more respective software applications operating on the mobile device 2 and the computer 1.

In some embodiments of the present invention, the computer 1 broadcasts a Bluetooth signal using the network interface 1h, which can be detected, when in range, by the network interface 2h of the mobile device 2. That is, the computer 1 provides a wireless access point to which other devices can connect. Referring to FIG. 4, at step S1 the mobile device 2 determines if an access point has been detected. If an access point has not been detected, processing loops at step S1 until an access point is detected. That is, the mobile device 2 repeatedly scans for a suitable access point to which to connect. Upon detection of the Bluetooth signal broadcast by the computer 1, processing passes to step S2. At step S2 the mobile device 2 connects to the computer 1. At the same time, at step S2a, the computer 1 performs processing necessary to establish a connection with the mobile device 2. Upon establishing a connection, at the mobile device 2, processing passes to step S3, while at the computer 1, processing passes to step S3a. The user is prompted, on the display 1e of the computer 1, the display 2e of the mobile device 2, or both, to tap display 1e of the computer 1 three times with the mobile device 2. The tapping of the mobile device 2 on the display 1e generates three touch events which are detected independently by both the mobile device 2 and the computer 1. This generates two relative time intervals which are shared by each device to determine the offset of their respective system clocks. This offset is then used to synchronise the system clocks.

In more detail, from step S3 and S3a processing passes to step S4 and S4a respectively, at which the mobile device 2 and the computer 1 determine whether a touch event has been detected (i.e. whether the user has tapped the mobile device 2 against the screen 1e). As described above, detection of touch events at the mobile device 2 is carried out by processing data output by the sensor 2j. For example, where the sensor 2j is an accelerometer, detection of touch events may comprise processing data output by the accelerometer to identify rapid negative acceleration indicative of a collision. Detection of touch events at the computer 1 is performed by detecting touch events with a mobile device upon the touch sensitive display 1e.

Processing loops at steps S4, S4a until a touch event is detected. A timeout condition may be placed on the looped collision detection of steps S4, S4a after which processing may terminate, or return to steps S3, S3a to again prompt the user to complete the synchronisation process.

If, at step S4, it is determined that a touch event has been detected by the mobile device 2, processing passes to step S5 at which the mobile device 2 records the time of the detected touch event. Similarly, if, at step S4a, it is determined that a touch event has been detected by the computer 1, processing passes to step S5a at which the computer 1 records the time of the detected touch event. Processing then passes to steps S6, S6a respectively, at which it is determined whether three touch events have been recorded. If three touch events have not been recorded, processing passes back to steps S4, S4a respectively, at which the mobile device 2 and the computer 1 each await a further touch event.

If, at steps S6, S6a, it is respectively determined that three touch events have been recorded, processing at the computer 1 passes from step S6a to step S7a, at which the times recorded at the computer 1 are transmitted to the mobile device 2. Similarly, processing at the mobile device 2 passes from step S6 to step S7 at which the times recorded at the mobile device 2 are transmitted to the computer 1. Processing then passes from steps S7, S7a to steps S8, S8a at which the relative timings between the respectively recorded touch events are compared, and if it is determined that the relative timings match, the respective system clocks of the computer 1 and the mobile device 2 are synchronised. While, in the processing described above, each of the computer 1 and the mobile device 2 transmit recorded touch events to each other, in other embodiments of the present invention only one of the computer 1 or the mobile device 2 transmit recorded touch events to the other, such that the comparison of relative timings, and matching of paired devices is performed by the receiving device.

It will be appreciated that synchronisation of the system clocks of the computer 1 and the mobile device 2 is used to allow the determination of whether respectively detected touch events do, in fact, relate to the same touch event without requiring a comparison of relative timings for each detected touch event. It will further be appreciated that, during the initial synchronisation, the number of times that the user is asked to tap the screen 1e with the mobile device 2 may vary based upon a trade-off between an amount of time required for the user and a likelihood of observing the same relative timings for non-matching devices. Further, initial synchronisation of system clocks can be performed using other techniques, such as requiring a user to enter a pin on both the computer 1 and the mobile device 2 or requiring the user to perform a specific gesture with the mobile device 2 on the screen 1e, the performance of which being detected by each of the mobile device 2 and the computer 1.

In another embodiment of the present invention, the computer 1 does not provide an access point to which the mobile device 2 can connect directly. Instead, each of the computer 1 and the mobile device 2 are connected to a remote server 7 over the Internet. To initialise a connection, a user touches the mobile device 2 onto the screen 1e. The touch event is detected by both the mobile device 2 and the computer 1 independently, and reported by each to the remote server 7 along with further information recorded about the touch event, preferably including, from the computer 1 and mobile device 2, location information. The remote server 7 uses location information, the reported times, and other reported characteristics of the detected touch event to identify candidate pairs of matching devices. Having matched the mobile device 2 and the computer 1, a connection is established between the mobile device 2 and the computer 1, and their respective system clocks are pairwise synchronised.

After initial pairing, synchronisation of the mobile device 2 with the computer 1 can be achieved using the Network Time Protocol (NTP).

Once the clocks of the computer 1 and the mobile device 2 have been pairwise synchronised, further touches of the mobile device 2 upon the display 1e of the computer 1 can be associated with the mobile device 2. An example of processing performed by the computer 1 and the mobile device 2 to process further touch events is now described with reference to FIG. 5.

At step S10 a further touch event is detected by the mobile device 2, and at step S10a, the same touch event is detected by the computer 1. Processing then passes to step S11 at the mobile device 2 and step S11a at the computer 1, at which the mobile device 2 and computer 1 record the detected touch event with a timestamp based upon their respective (synchronised) system clocks. The computer 1 further records the coordinates of the display 1e at which the detected touch event occurred. Both the computer 1 and the mobile device 2 may record further information relating to the detected touch event, depending upon the respective sensors of, and information available to, the mobile device 2 and the computer 1. For example, the mobile device 2 may comprise further sensors, such as a GPS sensor (not shown). Data sampled from such further sensors may be associated, and recorded, with detected touch events.

At the mobile device 2, processing passes from step S11 to step S12 at which the mobile device 2 transmits a notification of a detected touch event, along with a timestamp, an identifier identifying the mobile device 2 (the identifier uniquely identifies the mobile device 2 among other devices paired with the computer 1), and any further data recorded by the mobile device 2 in connection with the touch event, to the computer 1 (the transfer of data is represented in FIG. 5 as a dashed line from step S12 to step S12a). At the computer 1, processing passes from step S11a to step S12a at which the computer 1 receives the notification from the mobile device 2. Processing passes from step S12a to step S13a at which the computer 1 compares the timestamp indicated in the received notification with timestamps recorded by the computer 1 for touch events detected by the computer 1, to determine if a match exists (i.e. if the computer 1 detected a touch event at the same time as the mobile device 2). In determining whether a reported touch event matches a detected touch event, the computer 1 may require that the reported timestamps are equal within a certain matching tolerance. Such a matching tolerance may be determined based upon a known touch event detection delay for each of the mobile device 2 and the computer 1. Such detection delays may depend upon, for example, the sampling rate of sensors used to detect touch events. A suitable matching tolerance T is shown in equation (1):

T=max(Dm, Ds)+2C (1)

where Dm is the maximum touch event recognition delay of the mobile device 2, Ds is the maximum touch event recognition delay of the computer 1, C is the upper bound of the offset between the respective system clocks of the computer 1 and the mobile device 2 after synchronisation.

If, at step S13a it is determined that a match exists, processing passes to step S14a at which the computer 1 collates data recorded by the computer 1 for that touch event with the data received from the mobile device 2 for that touch event. Similarly, the computer 1 may transmit any data recorded by the computer 1 (for example, the coordinates of the touch on the screen 1e) to the mobile device 2 (represented as a dashed line from step S14a to step S13). Applications running on the computer 1 and the mobile device 2 can use the information about the matched touch event to facilitate interactions, with the interactions processed on the mobile device 2 in step S14 and on the computer 1 in step S16a.

If, at step S13a, it is determined that a match does not exist for the detected touch event (for example, due to a collision caused by a plurality of mobile devices attempting to interact with the computer 1 simultaneously), processing passes to step S15a where the user is prompted to repeat the touch event, and from step S15a to step S10a.

Upon detecting a matched touch event, program code is executed on one or both of the computer 1 and the mobile device 2. Different program code may be selected, depending on the context of the collision. Examples of interactions with the computer 1 using the mobile device 2 as a pointing device in accordance with embodiments of the present invention are now described.

In a first example, an icon representing data stored on the computer 1 is displayed on the display 1e of the computer 1. Selection of the data is effected by touching a part of the mobile device 2 (for example a corner) onto the displayed icon. Touching the mobile device 2 onto the display 1e generates a touch event which is detected by both the computer 1 and the mobile device 2 as described above with reference to FIG. 5. At the end of the processing of FIG. 5, the computer 1 knows the identity of the mobile device 2 that is associated with the touch event, and can determine the icon displayed on the display 1e at which the touch event occurred. In the present example, this information is used to execute computer program code on the computer 1 to transmit (a copy of) the data associated with the selected icon to the mobile device 2 over the connection 3, and to execute corresponding code on the mobile device 2 to receive the file.

In a related example, a user may select, using either the mobile device 2, or the computer 1, a file stored on the mobile device 2. The user may then touch (with a finger, stylus or the mobile device 2) the display 1e to initiate transfer of (a copy of) that file to the computer 1 for display on the display 1e. For example, a user may select a plurality of photographs taken using a camera of the mobile device 2 (not shown), wherein touching the display 1e causes those photographs to be transferred to the computer 1, and displayed upon the display 1e for further interaction.

In another example, touching the mobile device 2 onto a text entry field (for example on a webpage) displayed on the display 1e invokes text input means to be displayed on the display 2e of the mobile device 2, thereby allowing entry of text into the displayed text field, remotely from the mobile device 2 (using for example, the keyboard 2f). This allows a user to enter text (for example a password) privately, even where the display 1e is publicly viewable.

In another example, more complex input means displayed on the display 1e are displayed on the display 2e of the mobile device 2 to permit data entry, such as menus for selection of options, gesture or graphical input means (including writing and signatures), file upload or download means (including images and multimedia), card reading means, and biometric input means (where the mobile device 2 provides this).

In a further example, the mobile device 2 is laid along an edge onto display 1e, so that the display 2e is at an angle with respect to the display 1e. This creates a small private display space combining display 2e of the mobile device 2 with a portion of adjacent display 1e on the computer 1. The mobile device 2 effectively shields a part of the display 1e from other users' view. The computer 1 recognises that the device 2 is lying on the display 1e, and treats the line of contact as a cut or discontinuity in the display 1e, and as providing a virtual link to device 2. The resulting combined display space is available for direct manipulations, such as sliding content from the display 2e onto the display 1e, using finger touch interactions; and vice versa by sliding content along the display 1e towards the mobile device 2, and hence seamlessly onto display 2e.

Further interaction may utilise the sensors of the mobile device 2 (for example, the sensor 2j). Touching the mobile device 2 onto an element displayed on the display 1e can allow that element to be manipulated by corresponding movement of the mobile device 2, for example rotation. Such manipulation may be used to interact with controls of a user interface such as dials, or sliders.

The mobile device 2 may be used to provide further information regarding elements displayed on the screen 1e, wherein touching an element on the screen 1e with the mobile device 2 causes such additional information (for example, information of particular interest to the user of the mobile device 2) on the screen 2e of the mobile device 2. For example such further information may be text and/or data and/or graphics and/or multimedia.

In this regard, an element displayed on the screen 1e may use a language which a user of the mobile device 2 does not understand. Touching the mobile device 2 onto that element may cause a translation to be displayed and/or played on the mobile device 2 in a language understandable by the user of the mobile device 2. The translation may be performed by either the mobile device 2 directly, or by the computer 1 and sent to the mobile device 2 for display on the screen 2e. In either case, the language of translation may be determined by a language used by the mobile device 2. Equally with regard to the element displayed, computer 1 may hold a store of underlying information in multiple languages, and computer 1 may then select the information from store in the respective language (if available) requested by mobile device 2,

In addition to visual feedback, use of the mobile device 2 as a pointer and selection tool for the computer 1 can allow visual information displayed on the screen 1e of the computer 1 to be combined with haptic and/or auditory information to be relayed to the user through appropriate components of the mobile device 2. For example, the mobile device 2 may comprise a vibration device and/or a speaker. A user may, for example, drag the mobile device 2 along the screen 1e, which may cause the mobile device 2 to vary haptic and/or auditory feedback depending upon the content displayed on the screen 1e. Such feedback can be used for a number of applications, for example as an aid for the visually impaired. In this example, the mobile device 2 may vibrate and/or provide predetermined sounds when a user moves the mobile device 2 over particular elements on the screen 1e, thereby allowing the user to recognise those elements without needing to see them.

Similarly, the screen 1e may comprise a plurality of elements each relating to respective audio and/or multimedia files. Selecting a particular file with the mobile device 2 may cause the mobile device 2 to output all or part of the audio and/or multimedia data contained within that file using a speaker, or headphones, connected to the mobile device 2. In this way, a private feedback channel is provided (especially where headphones are used with the mobile device 2) for publicly accessible data.

The display of the mobile device 2 may be utilised as a proxy for manipulating elements displayed on the screen 1e. For example, a user may select an element displayed on the screen 1e using the mobile device 2, and such selection may cause a representation of the selected element to be displayed on the screen 2e, allowing the user to manipulate that element through interaction with the screen 2e.

Similarly, touching the mobile device 2 onto an element displayed on the screen 1e and subsequently, or simultaneously, pressing a physical, or virtual, button on the mobile device 2 may trigger a corresponding action to be performed by the computer 1.

The present invention may further be used to facilitate payment for items displayed on the display 1e. For example, touching the mobile device 2 onto an image displayed on the display 1e may cause a payment form to appear on the display 2e. A user may then complete the payment form using the mobile device 2. Having completed the payment form, a second touch of the mobile device 2 onto the image displayed on the display 1e initiates payment. Alternatively, payment information may be pre-stored on the mobile device 2, such that payment is affected instantly, or upon completion of a confirmation step by a user of the mobile device 2. If the purchased item is a physical item, the computer 1e may transmit a collection code to the mobile device 2 (or output such a collection code by way of a printer (not shown) attached to the computer 1). If the purchased item is software (including multimedia data) it may be transmitted by computer 1 to device 2 after authorisation of payment. In this way, a “shop wall” may be provided, allowing a user to view, purchase, and download digital content (or arrange collection or delivery of physical goods) thereby combining the experience of online and physical retail.

As a further example, the result of payment or authentication may be the delivery of an electronic ticket or voucher of some kind. This may be delivered directly to the mobile device 2, and may be a transport boarding card, an electronic ticket allowing access to an event or location, a token enabling collection of goods, a voucher, or a sales receipt. Such tickets may be delivered in a variety of formats, including text, images, linear barcodes and multi-dimensional barcodes. As a specific example, a user may touch their mobile device 2 onto a self-check-in terminal at an airport, where the computer 1 (here providing the terminal functionality) retrieves and validates an electronic ticket stored on the mobile device 2. The computer 1 transfers an electronic boarding card directly to the mobile device 2, which may be viewed on the display 2e and used during the boarding process.

Touching the mobile device 2 onto the computer 1 may cause an application running on the mobile device 2 to be displayed on the screen 1e. Alternatively, a part of that application, such as an application menu, may be displayed on the screen 1e. Further, menus or commands displayed on the screen 1e (for example, delete and paste commands, or menus to modify attributes such as colour or brightness of a photograph in a photograph editing application) may be “picked up” by the mobile device 2 by selecting the menu with the mobile device 2. The menu is then transferred to the mobile device 2 where it is permanently available for use (amongst other pre-stored or picked up commands and menus). Users can select one or multiple of the commands on the mobile device 2 and apply them to objects displayed on the surface by direct touch.

In general terms, actions taken by, and feedback received from, the computer 1 in response to interactions with elements displayed on the display 1e by the mobile device 2 may be customized for specific users or contexts based upon information stored on the mobile device 2 and provided to the computer 1.

For example, touching the mobile device 2 onto the screen 1e may cause an application menu to be displayed on the screen 1e. The application menu which is displayed on the screen 1e may be customized using information transmitted to the computer 1 from the mobile device 2.

The computer 1e may display an “undo” control on the screen 1e. Applications operating on the computer 1 and the mobile device 2 may be arranged such that touching the mobile device 2 onto such an undo control displayed on the computer 1 can be undo changes previously performed by the mobile device 2 on the computer 1e.

While the computer 1 is displaying, for example, a web browser, touching the mobile device 2 onto a bookmark control displayed on the computer 1 may show bookmarks provided by the mobile device 2 on the computer 1. That is, the user of the mobile device 2 may provide their own bookmarks (stored on the mobile device 2) and use these personal bookmarks when interacting with the computer 1.

The mobile device 2 may store personal details about a user of the mobile device 2. In this way, forms displayed on the display 1e may be automatically completed or partly completed by selection of those forms with the mobile device 2.

To prevent accidental activation of certain critical functions on computer 1 via mobile device 2, the user may be required to perform counter-intuitive secondary actions with the mobile device 2. For example, in order permanently to delete items from the computer 1, a user may be required to perform a touch operation (in a manner described above), but also to perform a simultaneous physical rotation of the mobile device 2. Such motion gestures may be detected using sensors 2j. Other examples will be apparent to those skilled in the art.

Some controls of the computer 1 may be restricted to users having particular permissions. Touching the mobile device 2 onto a restricted control displayed on the computer 1 may enable that control to be used (and associated functions to be executed) by means of the mobile device 2 providing required authentication credentials pre-stored on the mobile device 2. A user of the mobile device 2 may touch the mobile device 2 onto an access or login control displayed on the computer 1 to perform the associated login action using credentials provided by the mobile device 2.

As a further example, users may move or copy parts of the graphical user interface shown on the display 1e of computer 1, to their mobile devices 2—for example, tool palettes or menus. To usesuch a tool or command, the user selects it on the display 2e and then touches the computer display 1e to cause it to execute. Tools are thus ready-to-hand when needed. Users may customise the set of interface elements available on their mobile devices 2. In principle any interface element which is available on the computer screen 1e can be picked up with the mobile device 2 by touch, and such interface elements can be re-arranged and grouped on the mobile device 2 to match workflows. Multiple users may each assemble different, individually customised, interfaces to use in the same application running on the computer 1.

Touching the mobile device 2 onto the computer 1 may display, on the screen 1e, a virtual lens on the computer 1 adjacent to a current location of the mobile device 2 on the screen 1e. The displayed lens may move accordingly when the mobile device is dragged on the screen 1e. The lens may disappear again on lifting the mobile device 2 from the screen 1e. All finger touches occurring within the lens are interpreted as belonging to the mobile device 2 and, by association, its user. All content displayed under the lens can therefore be customized using information supplied by the mobile device 2.

Similarly, a virtual lens may be displayed on the screen 1e, through which, hidden information, belonging to a user of the mobile device, may be made visible. When a displayed virtual lens is moved over an access or login control, finger touches performed on the screen 1e through the lens, can be arranged to cause the login action to be executed using credentials provided by the mobile device 2.

All finger touches performed through a virtual lens associated with a mobile device 2, can be attributed to the mobile device 2 to create an audit trail.

While the above description is concerned with a single mobile device interacting with a computer, it will be appreciated that a plurality of mobile devices may be used simultaneously, for example by one user or different users. Considering the examples above, a plurality of users may each select a different audio or multimedia file for playing through respective mobile devices. As a further example, multiple users may overlap their respective virtual lenses to provide a combined filter (for example, in which may displayed contacts common to both users).

Mobile devices of one or multiple users may each interact with the computer 1, and may interact with each other, using the computer 1 as an intermediate device.

Equally, mobile devices 2 of one or multiple users may interact with each other, using the computer 1 as an introductory device. In this case, the computer 1 facilitates synchronous data transfer between multiple mobile devices 2, using the computer 1 in a mediating role. A user wishing to send data selects the data on the mobile device 2 and then touches the computer display 1e with the mobile device 2 to open a transmission area (indicated visually on display 1e). Other users who wish to receive the data, select a suitable function on their mobile devices 2 and touch the computer display 1e in the displayed transmission area. Data transmission may proceed indirectly via computer 1, but preferably computer 1 provides an “electronic introduction” (exchanging device names and addresses) between a pair of mobile devices 2 so that data may be exchanged directly and privately between respective mobile devices. Preferably the computer display 1e displays an image or animation indicating transmission between sender and receiver mobile devices 2. This technique enables users who collaborate around shared computers 1 to transfer data between their mobile devices 2, without direct knowledge of the names or addresses of other users' mobile devices 2. The role of the computer 1 is to provide an intuitive visual context through which peer-to-peer transfer between mobile devices 2 can be initiated and visualised. This functionality is not limited to a single pair of mobile devices 2, but also allows a plurality of simultaneous one-to-many and many-to-one transfers, because multiple mobile devices 2 can participate.

While the above interactions are all concerned with utilisation of the mobile device 2, some operations are more appropriately performed using a user's fingers or a stylus. For example, operations to expand pictures displayed on the display 1e may be more easily performed using a user's fingers. The computer 1, therefore allows interaction using a user's fingers and/or a stylus in addition to interaction using a mobile device 2. It is therefore necessary to discriminate between a touch event caused by the mobile device 2 being touched onto the screen 1e, from touch events caused by touches of a user's fingers or a stylus onto the screen 1e. Such a discrimination may be performed using any appropriate means, and may be based upon a contact area on the display 1e of a touch event.

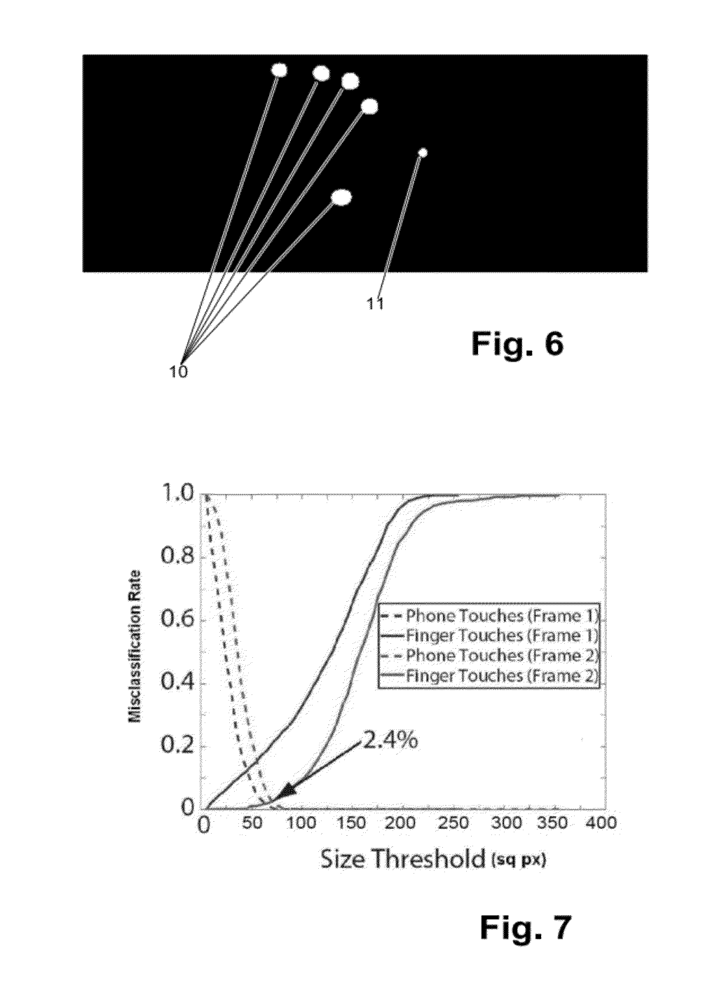

In experiments, it has been determined that contact area provides a reliable method of determining whether a touch event on a display is caused by a mobile device or a user's finger FIG. 6 illustrates an example of contact areas recorded in a previous experiment. Five contact areas 10 are caused by user's fingers, while a contact area 11 is caused by a mobile telephone. The experiment utilized a custom built interactive tabletop with an active surface area of 91 cm×57cm and a rear-projected screen with a resolution of 1280 px×800 px. A camera with a resolution of 640 px×480 px captured images of the surface at 120 Hz. Touch detection was based upon computer vision processing of the captured images in combination with FTIR. The captured images were subject to highpass, dilation, and thresholding filters, after which any objects in contact with the surface were clearly visible. Contact areas were extracted by identifying connected components.

Twelve (12) adult participants successively touched targets appearing on the screen at pseudo-random locations. The participants first touched sixty-four (64) targets with a mobile telephone, and then repeated the exercise with their fingers. Contact areas were analyzed over four frames captured after touch detection. While large variations were observed, the mean contact areas of touches of a mobile phone were measurably smaller than those of the participant's fingers (as shown in FIG. 6). It will be appreciated that a threshold, at which an observed contact area is to be classified as being caused by a mobile device, will be selected based upon the requirements of a particular application.

FIG. 7 illustrates the effect of varying the size threshold (in px²) on the misclassification rates of fingers and mobile telephones. For example, in the above described experiment, it was determined that when selecting a threshold such that all touches of a mobile telephone are correctly identified, 9.5% of touches of a user's finger will be misclassified. For classification in the second frame, a threshold of around 70 px² resulted in an optimum trade-off, with a misclassification rate of 2.4% for both fingers and mobile telephones.

Alternative methods of touch detection, and discrimination may be used. For example, where contact microphones may record the sound caused by touch events, and those sounds may subsequently be processed to determine whether the sound was caused by a finger a mobile device.

The functionality available to the user of mobile device 2 may be extended by additional executable software components (“plug-ins”), which may be locally stored at computer 1, for example on the hard disk drive 1c. The purpose of such plug-ins is to enable new interactions between the computer 1 and mobile devices 2. The plug-in components are downloaded from computer 1 to a mobile device 2 on demand (for example during the first touch interaction). The use of plug-in components allows application developers to add new functionalities without direct access to applications on the mobile devices 2. The user of a mobile device 2 installs a single basic software application, which may later be dynamically extended through plug-ins. This avoids the need to repeatedly install new versions of the basic software application in order to add new functionalities. Preferably the application on computer 1 and the plug-ins that it provides both carry unique identifiers, which allow for correctly associating components that are compatible. As an example: it may be desired to allow users to set the background image (“wallpaper”) of their mobile device's screen 2e in a single step by touching an image displayed on the computer screen 1e. Communication software would simply download such an image to storage library of the mobile device 2. To enable the setting of wallpapers directly, a plug-in providing this extra functionality is stored on the computer 1, then downloaded and installed on the mobile device 2. Thereafter, operating the plug-in enables the user to touch an image displayed on the computer display 1e, and automatically set the wallpaper on the mobile device's display 2e accordingly.

Other uses of the present invention, within the scope of the attached claims, will be readily apparent to those skilled in the art.

1. A method of interacting with a first electronic device having a touch-sensitive display, the method comprising:
establishing a connection between said first electronic device and a second electronic device, said connection allowing data communication between the first electronic device and the second electronic device;
detecting a first event involving said first electronic device;
detecting a second event involving said second electronic device;
determining if said first event and said second event relate to an interaction between said second electronic device and an element displayed on said touch-sensitive display;
if said first and second events relate to an interaction between said first and second electronic devices, controlling operation of said first electronic device based upon one or more characteristics of said interaction.

2. A method according to claim 1, wherein establishing a connection between said first electronic device and said second electronic device comprises synchronising respective system clocks of said first and second electronic devices.

3. A method according to claim 2, further comprising associating said first event with a first time indicated by the system clock of said first electronic device when the first event was detected; and
associating said second event with a second time indicated by the system clock of said second device.

4. A method according to claim 3, wherein determining if said first event and said second event relate to an interaction between said second electronic device and an element displayed on said touch-sensitive display comprises:
determining if said first time and said second time meet a predetermined criterion.

5. A method according to claim 4, wherein said predetermined criterion is that said first time and said second time are equal to within a predetermined tolerance.

6. A method according to claim 1, wherein said first event is a touch event between said first electronic device and said second electronic device.

7. A method according to claim 1, wherein said element is associated with a data item stored at said first electronic device; and
wherein controlling operation of said first electronic device comprises transmitting said data item to said second electronic device.

8. A method according to claim 1, further comprising:
if said first and second events relate to an interaction between said second electronic device and an element displayed on said touch-sensitive display, controlling operation of said second electronic device based upon one or more characteristics of said interaction.

9. A method according to claim 8, wherein controlling operation of said second electronic device comprises transmitting a data item from said second electronic device to said first electronic device.

10. A method according to claim 8, wherein said element is associated with a first data entry field displayed on said touch-sensitive display and wherein controlling operation of said second electronic device comprises providing a second data entry field on said second electronic device corresponding to said first data entry field; and
transmitting from said second electronic device data entered at said second data entry field to said first electronic device for inputting into said first data entry field.

11. A method according to claim 8, wherein controlling operation of said second electronic device comprises controlling operation of the second electronic device to provide feedback based upon one or more characteristics of said interaction, said feedback comprising at least one of audio visual or haptic feedback.

12. A method according to claim 1, wherein said characteristic of said interaction is dependent upon whether a button of said second electronic device was activated during said interaction.

13. A method according to claim 12, wherein said button is a virtual button displayed on a touch-sensitive display of said second electronic device.

14. A method according to claim 1, wherein said characteristic of said interaction is dependent upon a spatial orientation of said second electronic device during said interaction.

15. A method according to claim 1, wherein said characteristic of said interaction is dependent upon data stored at the second electronic device.

16. A method according to claim 1, wherein controlling operation of said first electronic device comprises initiating a payment based upon payment data stored at or input via said second electronic device.

17. A method according to claim 1, wherein said element is a plurality of elements.

18. A method according to claim 1, wherein said second electronic device is a mobile device.

19. A method of interacting with a first electronic device having a touch-sensitive display, the method comprising:
at said first electronic device:
establishing a connection with a second electronic device, said connection allowing data communication between said first electronic device and said second electronic device;
detecting a first event;
determining if said first event relates to an interaction between an element displayed on said touch-sensitive screen and said second electronic device; and
if said first event relates to an interaction between an element displayed on said touch-sensitive screen and said second electronic device, controlling operation of said first electronic device based upon one or more characteristics of said interaction.

20. A method according to claim 19, wherein establishing a connection with said second electronic device comprises synchronising the system clock of said first electronic device to the system clock of second electronic devices.

21. A method according to claim 20, further comprising receiving an indication of a second event detected by said second electronic device.

22. A method according to claim 21, further comprising associating said first event with a first time indicated by the system clock of said first electronic device when the first event was detected; and
associating said second event with a second time indicated by the system clock of said second device.

23. A method according to claim 22, wherein determining if said first event relates to an interaction between an element displayed on said touch-sensitive screen and said second electronic device comprises determining if said first time and said second time meet a predetermined criterion.

24. A method according to claim 23, wherein said predetermined criterion is that said first time and said second time are equal to within a predetermined tolerance.

25. A method according to claim 19, wherein said first event is a touch event between an element displayed on said touch-sensitive screen and said second electronic device.

26. A method according to claim 19, wherein said element is associated with a data item stored at said first electronic device; and
wherein controlling operation of said first electronic device comprises transmitting said data item to said second electronic device.

27. A method according to claim 19, further comprising:
if said first event relates to an interaction between an element displayed on said touch-sensitive screen and said second electronic device, controlling operation of said second electronic device based upon one or more characteristics of said interaction.

28. A method according to claim 27, wherein controlling operation of said second electronic device comprises causing a data item to be transmitted from said second electronic device to said first electronic device.

29. A method according to claim 27, wherein said element is associated with a first data entry field displayed on said touch-sensitive display and wherein controlling operation of said second electronic device comprises causing a second data entry field to be provided on said second electronic device corresponding to said first data entry field; and
receiving at said first electronic device from said second electronic device data entered at said second data entry field for inputting into said first data entry field.

30. A method according to claim 19, wherein said characteristic of said interaction is dependent upon whether a button of said second electronic device was activated during said interaction.

31. A method according to claim 30, wherein said button is a virtual button displayed on a touch-sensitive display of said second electronic device.

32. A method according to claim 19, wherein said characteristic of said interaction is dependent upon an indication of a spatial orientation of said second electronic device during said interaction, received from said second electronic device.

33. A method according to claim 19, wherein controlling operation of said first electronic device comprises initiating a payment based upon payment data stored at or input via said second electronic device.

34. A method according to claim 19, wherein said element is a plurality of elements.

35. A method according to claim 19, wherein said second electronic device is a mobile device.

36. A method of interacting with a first electronic device having a touch sensitive display, comprising:
at a second electronic device:
establishing a connection with said first electronic device, said connection allowing data communication between said first electronic device and said second electronic device;
detecting a first event;
determining if said first event relates to an interaction between an element displayed on said touch-sensitive screen and said second electronic device; and
if said first event relates to an interaction between an element displayed on said touch-sensitive screen and said second electronic device, executing computer program code, said execution being based upon one or more characteristics of said interaction.

37. A method according to claim 36, wherein establishing a connection with said first electronic device comprises synchronising the system clock of said second electronic device with the system clock of said first electronic device.

38. A method according to claim 37, further comprising receiving an indication of a second event detected by said first electronic device.

39. A method according to claim 36, further comprising associating said first event with a first time indicated by the system clock of said second electronic device when the first event was detected.

40. A method according to claim 39, wherein determining if said first event relates to an interaction between an element displayed on said touch-sensitive screen and said second electronic device comprises:
transmitting an indication of said first event and said first time to said first electronic device.

41. A method according to claim 36, wherein said first event is a touch event between an element displayed on said touch-sensitive screen and said second electronic device.

42. A method according to claim 36, wherein said element is associated with a data item stored at said first electronic device; and
wherein executing computer program code comprises executing computer program code to receive said data item from said first electronic device.

43. A method according to claim 36, wherein executing computer program code on said second electronic device comprises transmitting a data item from said second electronic device to said first electronic device.

44. A method according to claim 36, wherein said element is associated with a first data entry field displayed on said touch-sensitive display and wherein executing computer program code on said second electronic device comprises causing a second data entry field to be provided on said second electronic device corresponding to said first data entry field; and
transmitting to said first electronic device data entered at said second data entry field for inputting into said first data entry field.

45. A method according to claim 36, wherein said characteristic of said interaction is dependent upon whether a button of said second electronic device was activated during said interaction.

46. A method according to claim 45, wherein said button is a virtual button displayed on a touch-sensitive display of said second electronic device.

47. A method according to claim 36, wherein said characteristic of said interaction is dependent upon an indication of a spatial orientation of said second electronic device.

48. A method according to claim 47, further comprising transmitting said indication of a spatial orientation of said second electronic device to the first electronic device.

49. A method according to claim 36, wherein executing computer program code comprises initiating a payment based upon payment data stored at or input via said second electronic device.

50. A method according to claim 36, wherein said element is a plurality of elements.

51. A method according to claim 36, wherein said second electronic device is a mobile device.

52. A computer readable media carrying computer readable instructions configured to cause two computers to carry out a method according to claim 1.

53. A computer readable medium carrying computer readable instructions configured to cause a computer to carry out a method according to claim 19.

54. A computer readable medium carrying computer readable instructions configured to cause a computer to carry out a method according to claim 36.

55. A computer apparatus for interacting with a first electronic device having a touch sensitive display, comprising:
a first electronic device including:
a touch sensitive display;
a memory storing processor readable instructions; and
a processor arranged to read and execute instructions stored in said memory; and
a second electronic device including:
a memory storing processor readable instructions; and
a processor arranged to read and execute instructions stored in said memory;
wherein said processor readable instructions comprise instructions arranged to control the computer apparatus to carry out a method according to claim 1.

56. A computer apparatus for interacting with a first electronic device having a touch sensitive display, comprising:
a memory storing processor readable instructions; and
a processor arranged to read and execute instructions stored in said memory;
wherein said processor readable instructions comprise instructions arranged to control the computer to carry out a method according to claim 19.

57. A computer apparatus for interacting with a first electronic device having a touch sensitive display, comprising:
a memory storing processor readable instructions; and
a processor arranged to read and execute instructions stored in said memory;
wherein said processor readable instructions comprise instructions arranged to control the computer to carry out a method according to claim 36.
